(19) United States
(12) Patent Application Publication
(10) Pub. No.: US 2019/0071118 A1
(43) Pub. Date: Mar. 7, 2019

(54) DEVICE AND METHOD FOR MAINTAINING A PRODUCED HYDRAULIC PRESSURE

(71) Applicant: KNORR-BREMSE SYSTEME FUER NUTZFAHRZEUGE GMBH, Muenchen (DE)

(72) Inventors: Bernhard Miller, Weil der Stadt (DE); Falk Hecker, Markgroeningen (DE); Klaus Peterrreins, Filderstadt (DE)

(21) Appl. No.: 16/080,583

(22) PCT Filed: Feb. 23, 2017
(86) PCT No.: PCT/EP2017/054116

§ 371 Date: Aug. 28, 2018

(30) Foreign Application Priority Data
Mar. 4, 2016 (DE) 10 2016 002 555.7

(51) Int. Cl. B62D 5/065; B62D 5/30

(52) U.S. Cl. CPC B62D 5/065; F15B 20/007; B62D 5/30

(57) ABSTRACT

A device for maintaining a hydraulic pressure, which can be set by a pressure generator, including: an inlet for coupling to the pressure generator; an outlet for providing the hydraulic pressure; at least a first check valve, which is configured to open a flow path from the inlet to the outlet when a first opening pressure is exceeded and to prevent flow in the opposite direction; and a switching apparatus between the inlet and the outlet, wherein the switching apparatus is configured to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure. Also described are a hydraulic system, a power-steering system, vehicle, and method.

### FIELD OF THE INVENTION

The present invention relates to a device and a method for maintaining a produced hydraulic pressure and in particular to a hydraulic proportional valve for a steering control and an electrically operated hydraulic power steering.

### BACKGROUND INFORMATION

In various hydrostatic servo drives for steering gear controls there are believed to be two problems which have only been inadequately solved thus far. One involves the maintaining of high pressure loads, such as occur during a continuous loading. A second problem involves the significant steering resistance upon system failure, which drivers must exert in order to steer the vehicle in the case of conventional systems.

FIG. 8 shows for example a conventional system, in which a steering gear 90 is hydraulically operated. The hydraulic pressure is produced by a pressure generator 50 with a motor 51 (e.g., a pump). The steering gear 90 comprises two working cylinders 91, 92, which are separated by a piston 93. If one of the two working cylinders is pressurized with a hydraulic pressure, this results in a movement of the piston 93 and thereby a steering of the vehicle in one direction. If the other working cylinder is subjected to pressure, the piston moves in the opposite direction, which in turn results in a steering in the opposite direction. Thus, when driving along a curve an increased pressure is built up in the one working cylinder, while when driving along an opposite curve an increased pressure is built up in the opposite working cylinder. Furthermore, a first check valve 70 and a second check valve 80 are configured in the conventional system, being connected to a surge tank 60.

The first problem mentioned above comes about if one wheel of the vehicle is blocked during a steering demand (for example, it is pressing against a curb stone) and the motor 51 must maintain the high pressure. The same applies if the vehicle is driving along a long curve, where the pressure needed for this has to be provided constantly by the motor 51. This constitutes an unwanted constant strain on the corresponding pump or the motor. Even if the steering pressure abates, the motor must convert the decreasing pressure for this system. The corresponding power loss during the relaxation process is thus provided by the pump/motor or transformed there into heat. This results in long-lasting permanent strain on the motor or the pump, which impairs the reliability and increases the wear.

The second problem mentioned above arises during a system failure, such as when the pump provides no steering assistance due to a power outage. In this case, the driver must expend additional force, besides the steering force, in order to move the pump 50 and still be able to steer the vehicle.

Hence there is a need for alternative solutions in order to maintain a hydraulic pressure without this placing a strain on the motor or the pressure generator.

### SUMMARY OF THE INVENTION

The aforementioned technical problem is solved by a device as described herein and a method as described herein. The further embodiments pertain to advantageous modifications of the device as described herein.

The present invention relates to a device which is suitable for maintaining a hydraulic pressure, which can be set by a pressure generator. The device comprises an inlet for coupling to the pressure generator, an outlet for providing the hydraulic pressure, at least a first check valve, which is configured to open a flow path from the inlet to the outlet when a first opening pressure is exceeded and to prevent flow in the opposite direction. Furthermore, the device comprises a switching apparatus between the inlet and the outlet, wherein the switching apparatus is configured to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure.

The inlet and the outlet of the device need not be an independent component, but instead can also constitute a connector to a pump or any given branch point along the (hydraulic) flow. The check valve should be interpreted broadly in the context of the present invention and will encompass any device which provides the defined function, i.e., one which enables an opening of the flow path when a minimum pressure is exceeded and prevents an opposite flow. Therefore, check valve may also be configured generally as a check fitting (e.g., a check flap). The defined, predetermined switching pressure merely constitutes a parameter which triggers the switching behavior of the switching apparatus. If the pressure produced is greater than the switching pressure, the switching apparatus is closed, and conversely it will be opened. The switching of the switching apparatus may occur independently of the hydraulic pressure at the outlet (the switching pressure does not depend directly on the pressure at the outlet).

In the context of the present invention the term “coupling” should be interpreted broadly and should encompass any connection by which an energy flow can be transferred (e.g., a fluidic flow of a hydraulic liquid). Furthermore, it is understood that an arrangement of one element A between two other elements B, C does not necessarily mean that element A is physically situated between elements B and C. Instead, it should also encompass arrangements where a hydraulic flow between elements B and C via element A is possible. The connections/couplings may be direct (without intervening elements) or indirect connections/couplings. In the latter case, one or more elements/components may be provided between the components connected.

In further sample embodiments, the switching apparatus comprises a control valve with a displaceable piston. The piston in a first position can open a flow path between the outlet and the inlet and in a second position close the flow path between the outlet and the inlet. The control valve may be configured to shift the piston into the first position if the pressure produced (at the inlet) is less than the switching pressure, and to shift it into the second position if the pressure produced (at the inlet) is greater than the switching pressure. Insofar as the pressure produced is equal to the switching pressure, either the first position or the second position can be taken up.

In further sample embodiments, the control valve has at least a first chamber and a spring. The device may further comprise a first control line, which connects the first chamber fluidically to the inlet, wherein the first control line brings about a pressure equalization between the first chamber and the inlet and the spring brings about a biasing of the piston in the direction of the first position, so that the switching pressure is defined by the spring.

In further sample embodiments, the pressure generator comprises a first pressure connector and a second pressure connector, wherein the inlet is coupled to the first pressure connector. The device may furthermore comprise a further inlet for coupling to the second pressure connector, a further outlet for providing a further hydraulic pressure, and a third check valve. The third check valve is adapted to open a flow path from the further inlet to the further outlet when a third opening pressure is exceeded and to prevent a flow in the opposite direction. The switching apparatus may also connect the further outlet and the further inlet and is adapted to reduce the further hydraulic pressure at the further outlet if a pressure produced by the pressure generator at the further inlet is less than the switching pressure, wherein the switching pressure is less than the third opening pressure.

The switching pressure defined here may also be chosen to be different from the previously defined switching pressure, so that the switching apparatus has asymmetrical behavior, i.e., it may require a higher (or lower) switching pressure for a movement into the first position than for the opposite movement. However, when used in a steering system, it is advisable to select both switching pressures the same.

Thanks to the defined function, the device can be used to relieve the pressure generator yet still maintain the hydraulic pressure at the outlet. The pressure generator only needs to maintain the switching pressure, but this is generally much less than a typical pressure produced by the pressure generator, resulting in the mentioned relieving.

In further sample embodiments, the switching apparatus comprises a second chamber and a further spring. The device furthermore comprises a second control line, which fluidically connects the second chamber to the further inlet. The second control line brings about a further pressure equalization between the second chamber and the further inlet. The further spring brings about a biasing of the piston in the direction of the second position, so that the switching pressure depends on the spring. Thus, the piston can move back and forth between a first opening position (first position) and a second opening position (second position). Furthermore, the piston may have passages which produce the connection between the outlet and the inlet or between the further outlet and the further inlet during the displacement.

In further sample embodiments, the device comprises an optional first throttling device along the first control line to bring about a throttling of the pressure equalization. Furthermore, the device may comprise a second throttling device along the second control line to bring about a throttling of the further pressure equalization. These throttlings bring about a dampening in order to prevent an unwanted excessive oscillation during the movement of the piston.

In further sample embodiments, the device may comprise an optional second check valve, which is configured between the switching apparatus and the inlet in order to make possible a flow from the switching apparatus when a second opening pressure is exceeded and to prevent a flow in the opposite direction, wherein the second opening pressure is greater than the switching pressure. Therefore, the first check valve and the second check valve open only above the pressure at which the piston is already moving in order to prevent the back flow from the outlet or from the further outlet.

Furthermore, the device may comprise a fourth check valve, which is configured between the switching apparatus and the further inlet in order to make possible a flow from the switching apparatus when a fourth opening pressure is exceeded and to prevent a flow in the opposite direction. The fourth opening pressure may be greater than the switching pressure.

In further sample embodiments, the second opening pressure of the second check valve is equal to the first opening pressure of the first check valve. Furthermore, the fourth opening pressure of the fourth check valve may be equal to the third opening pressure of the third check valve.

In further sample embodiments, the pressure generator is further adapted to make possible a back flow through the pressure generator from the one pressure connector when an idling pressure is exceeded at one of its pressure connectors, the switching pressure being chosen greater than the idling pressure. For example, the idling pressure is the pressure required in a currentless state to move the pressure generator passively so that higher pressures can be dissipated.

The present invention also relates to a hydraulic system with a pressure generator for producing a hydraulic pressure at a pressure connector and with one of the previously described devices. The pressure generator may comprise a hydraulic gear pump and the outlet and further outlet of the device may be coupled for example to a steering gear. The hydraulic gear pump may also be operated in reversed directions of running.

The hydraulic system with the device can be both an open hydraulic system and a closed hydraulic system.

The present invention also relates to a power steering with a steering gear and with the hydraulic system. The present invention furthermore relates to a vehicle with the power steering.

The present invention furthermore relates to a method for maintaining a hydraulic pressure which can be set by a pressure generator. The method involves the steps: opening a flow path from the pressure generator to an outlet if a first opening pressure is exceeded, in order to thereby build up the hydraulic pressure at the outlet; preventing a flow in an opposite direction; holding the hydraulic pressure until a pressure produced by the pressure generator is greater than a switching pressure; and reducing the hydraulic pressure if a pressure produced by the pressure generator is less than the switching pressure, wherein the switching pressure is less than the first opening pressure.

The present invention solves the aforementioned technical problem therefore by a switching apparatus (e.g., control valve) for an open or closed hydraulic system, wherein the working spaces of a gear pump, for example, are actuated. After reaching a target pressure—at permanently high system pressure—the gear pump can be largely relieved of pressure. Furthermore, this solution makes it possible to bypass the gear pump in a backup mode, so that the driver does not have to turn the gear pump with the motor in event of a system failure.

The permanently high system pressure can therefore withstand a continuous loading (e.g., during a blocking by a curb stone) without an increased power loss being sustained in the motor or at the pump.

The sample embodiments of the present invention will be better understood from the following detailed description and the accompanying drawings of the different sample embodiments, although these should not be understood to mean a limiting of the disclosure to the specific embodiments, and only serve for explanation and for comprehension.

### BRIEF DESCRIPTION OF THE DRAWINGS

FIG. 1 shows a device according to one sample embodiment of the present invention.

FIG. 2 shows further details of a sample embodiment of the present invention, which is integrated in an exemplary steering system.

FIG. 3 illustrates a first phase of an exemplary pressure build-up due to a steering demand.

FIG. 4 illustrates a second phase of the pressure build-up due to a steering demand.

FIG. 5 illustrates a subsequent pressure reduction in the exemplary steering gear.

FIG. 6 illustrates the functioning of a sample embodiment of the device during a steering movement in an opposite steering direction.

FIG. 7 shows a flow chart for a method according to one sample embodiment of the present invention.

FIG. 8 shows a conventional steering system.

### DETAILED DESCRIPTION

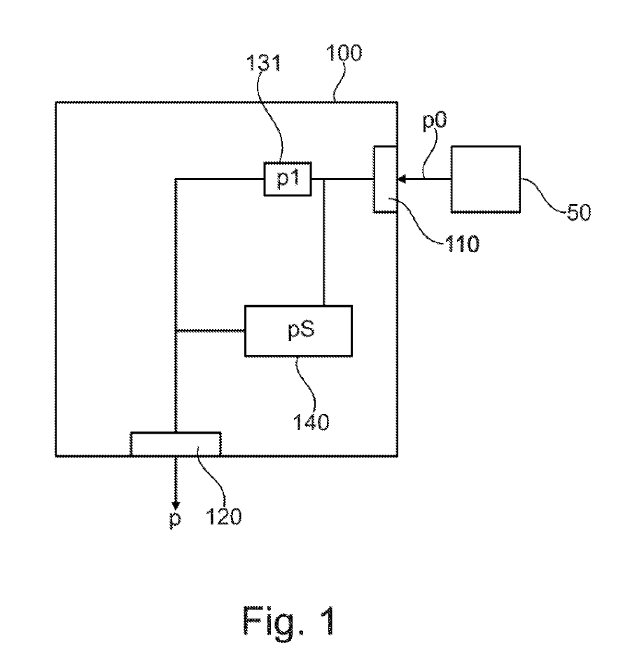

FIG. 1 shows a device 100 which is suitable for maintaining a hydraulic pressure p which can be set by a pressure generator 50. The device comprises an inlet 110 for coupling to the pressure generator 50, an outlet 120 for providing the hydraulic pressure p, at least one first check valve 131, which is adapted to open a flow path from the inlet 110 to the outlet 120 when a first opening pressure p1 is exceeded and to prevent a flow in the opposite direction. Furthermore, the device 100 comprises a switching apparatus 140 between the inlet 110 and the outlet 120. The switching apparatus 140 is configured to hold the hydraulic pressure p at the outlet 120 if, or as long as, a pressure p0 produced by the pressure generator 50 is greater than a switching pressure pS. This encompasses, for example, the entire range p0>pS and not just one value or a couple of values. Furthermore, the switching apparatus 110 can reduce the hydraulic pressure p at the outlet 120 if a pressure p0 produced by the pressure generator 50 is less than the switching pressure pS. The switching pressure pS is less than the first opening pressure p1.

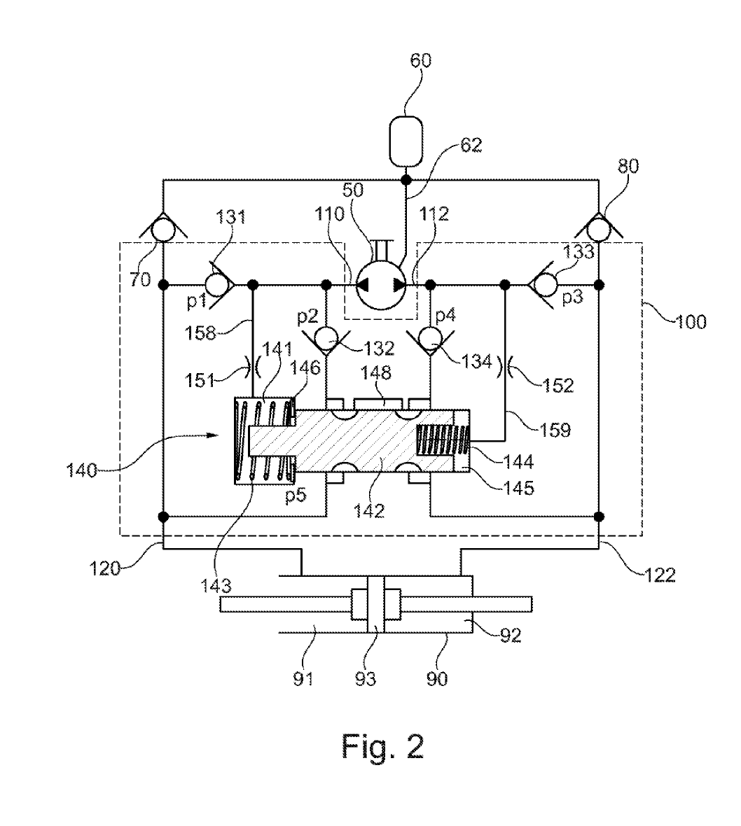

The sample embodiment shown in FIG. 1 may be integrated in an open hydraulic system or in a closed system (see FIGS. 2 to 6). The invention will not be confined to one of the two systems. Instead, the aspects described below may be configured likewise in an open hydraulic system. In order to economize on the description, only the closed hydraulic system shall be described more closely as an example.

FIG. 2 shows further details of a sample embodiment of the present invention, where the device 100 is integrated in an exemplary hydraulic steering with the pressure generator 50, a steering gear 90, a surge tank 60 and two check valves 70, 80. The steering gear 90 comprises a first working cylinder 91 and a second working cylinder 92, which are separated from each other by a working piston 93.

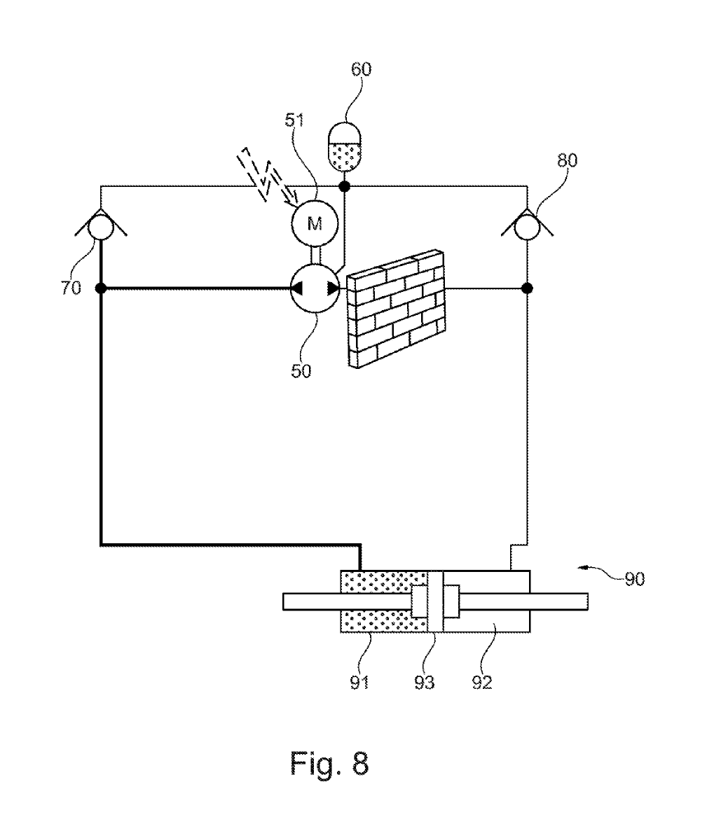

The hydraulic system shown differs from the conventional system of FIG. 8 by the additional components which are configured in the device 100 (see broken line box), wherein the device in the sample embodiment shown comprises in addition to the inlet 110 and the outlet 120 a further inlet 112 and a further outlet 122. The first working cylinder 91 is connected for example to the outlet 120 and the second working cylinder 92 to the further outlet 122, so that the working piston 93 can be moved by a hydraulic pressure at the outlet 120 in one direction and by a hydraulic pressure at the further outlet 122 in the opposite direction, in order to steer the vehicle.

The pressure generator 50 once again may comprise a gear pump and for example a first and a second pressure connector, to which the device 100 is coupled by its inlet 110 and further inlet 112. The overall system may be a fully encapsulated hydraulic system, so that the inlets 110, 112 and outlets 120, 122 can be defined for example as defined points along the hydraulic flow.

In the sample embodiment shown, the device 100 comprises a first check valve 131, a second check valve 132, a third check valve 133, a fourth check valve 134, the switching apparatus 140 and two throttling devices 151, 152. These components are fluidically situated between the inlet 110, the outlet 120, the further inlet 112 and the further outlet 122. The inlet 110 of the device 100 is coupled to the first pressure connector and the further inlet 112 to the second pressure connector of the pressure generator 50, so that the pressure generator 50 provides a controllable pressure p0 at the inlet 110 and/or at the further inlet 112.

Between the inlet 110 and the outlet 120 is situated the first check valve 131. Between the further inlet 112 and the further outlet 122 is situated the third check valve 133. Furthermore, the switching apparatus 140 connects the outlet 120 to the inlet 110 as well as the further outlet 122 to the further inlet 112, while between the switching apparatus 140 and the inlet 110 is configured the second check valve 132 and between the switching apparatus 140 and the further inlet 112 is configured the fourth check valve 134.

The first check valve 131 provides a flow path from the inlet 110 to the outlet 120 if a pressure is present at the inlet 110 which is above a first opening pressure p1 (and prevents an opposite flow). In the same way, the third check valve 133 provides a flow path from the further inlet 112 to the further outlet 122 if a pressure is present at the further inlet 112 which is above the third opening pressure p3 (and prevents an opposite flow). The second check valve 132 provides a flow path from the switching apparatus 140 to the inlet 110 if a pressure is present from the switching apparatus 140 which is above a second opening pressure p2 (and prevents an opposite flow). The fourth check valve 134 provides a flow path from the switching apparatus 140 to the further inlet 112 if a pressure is present from the switching apparatus 140 which is above a fourth opening pressure p4 (and prevents an opposite flow). The second opening pressure p2 for example may be equal to the first opening pressure p1 (e.g., around 8 bar). Furthermore, the third opening pressure p3 may for example be equal to the fourth opening pressure p4 (e.g., around 8 bar).

The switching apparatus 140 comprises a movable piston 142, a first chamber 141 and a second chamber 145, the first chamber 141 being situated opposite the second chamber 145 in the direction of movement of the movable piston 142. The piston 142 by its displacement changes the available volumes in the chambers 141, 145. Furthermore, the switching apparatus 140 comprises a spring 144 in the second chamber 145 and a further spring 143 in the first chamber 141. The spring 144 exerts a biasing on the displaceable piston 142, which forces the piston 142 into the first chamber 141. Likewise, the further spring 143 exerts a biasing on the piston 142, which forces the piston 142 into the second chamber 145.

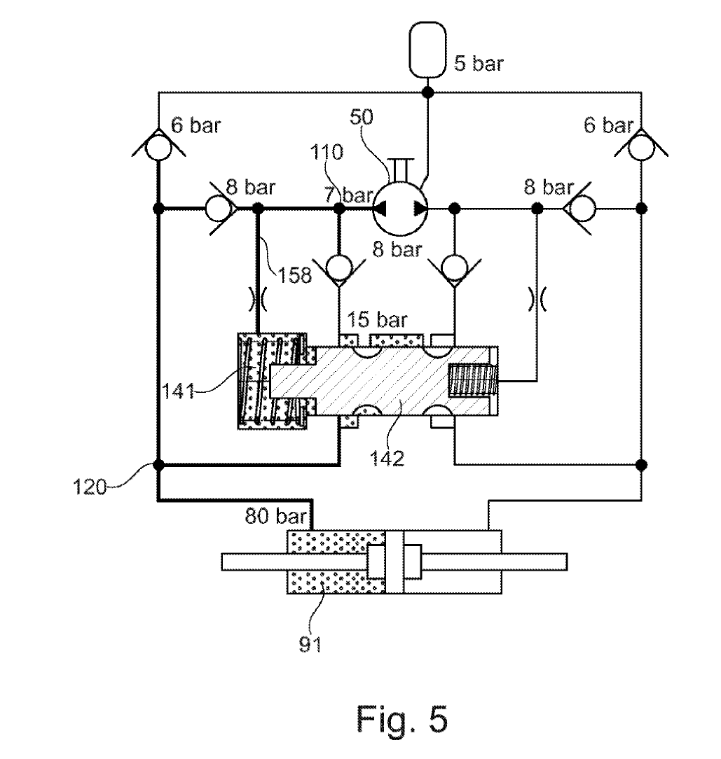

The piston 142 in the switching apparatus 140 may in particular be displaced between the following positions: a first opening position, a second opening position and a middle position. In the first opening position, the switching apparatus 140 opens only the flow path from the outlet 120 to the inlet 110. In the second opening position, the switching apparatus 140 opens only the flow path from the further outlet 122 to the further inlet 112 and in the middle position both mentioned flow paths are opened. The first opening position constitutes a first stop position, in which the piston 142 is situated the furthest to the left, while the second opening position constitutes a second stop position, in which the piston 142 is situated the furthest to the right. Furthermore, in the middle position, the outlet 120 can be connected to the further outlet 122 via a channel 148 in the switching apparatus 140. In a further middle position, although the two mentioned flow paths are opened, the outlet 120 is still not connected to the further outlet 122 (this situation is shown for example in FIG. 5, bottom).

In order for the flow paths to be provided by the switching apparatus 140, the displaceable piston 142 may have for example two depressions/bulges along its circumference, forming two passages. Thus, in the second opening position (displacement to the right in FIG. 2), one passage is fluidically connected to the further outlet 122 and the further inlet 112. After a displacement of the piston to the left into the first chamber 141 (first opening position), the other passage is fluidically connected to the outlet 122 and the inlet 112.

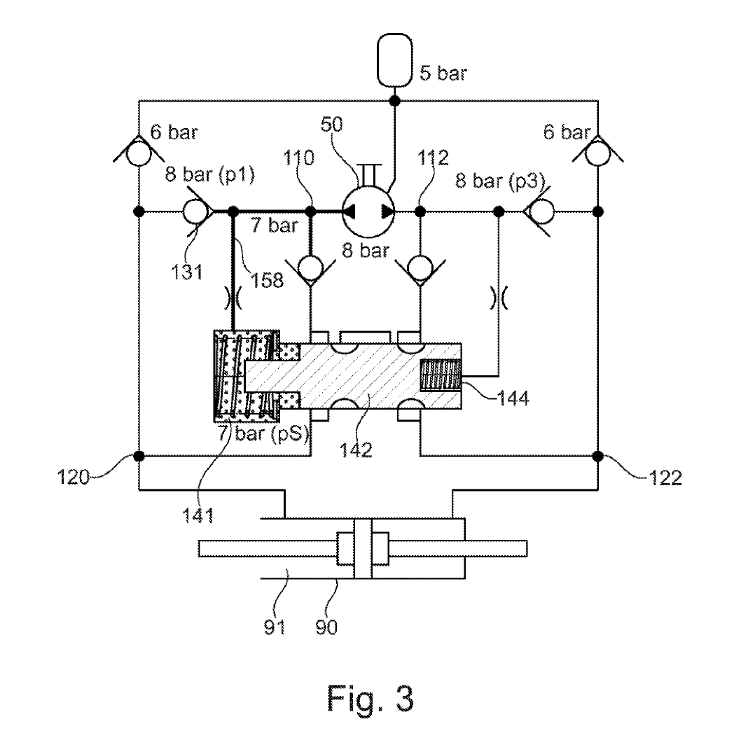

In order to displace the piston 142, as shown in FIG. 3, a switching pressure pS is required in the first chamber 141 or in the second chamber 145, which may be the same in magnitude for both directions, for example. However, this need not be the case. In further sample embodiments, a first switching pressure pS1 may be required in order to switch the switching apparatus 140 to the first opening position, and a second switching pressure pS2 (which is not equal to the first switching pressure pS1) may be required to switch the switching apparatus to the second opening position. Without limiting the invention to this, it shall be assumed in the following that the first switching pressure pS1 is equal to the second switching pressure pS2 (pS1=pS2=pS; e.g., around 7 bar). For steering systems, this is advantageous (in order to accomplish a symmetrical manipulation of the steering wheel). For other applications (such as lifting and lowering processes, as are used in crane equipment, for example), an asymmetrical design may be quite expedient (since the force of gravity can also assist).

Furthermore, the device 100 as shown in FIG. 2 has a first control line 158 from the inlet 110 to the first chamber 141 and a second control line 159 from the further inlet 112 to the second chamber 145. If the pressure increases along the first control line 158 and lies above the switching pressure pS of the switching apparatus 140, this causes the piston 142 to leave the position of rest and move to the second opening position (to the right in FIG. 2). On the other hand, if the pressure increases in the second control line 159 so much that the pressure in the second chamber 145 lies above the switching pressure pS, the piston 142 moves to the first opening position (to the left in FIG. 2).

In this way, the movable piston 142 can make possible a fluid flow from the outlet 120 to the inlet 110 and/or from the further outlet 122 to the further inlet 112 in dependence on the pressure relations in the first control line 158 and/or in the second control line 159. These fluid flows, however, are only possible if a pressure prevails along these flow paths which is above the second opening pressure p2 for the second check valve 132 or above the fourth opening pressure p4 of the fourth check valve 134. In the resting phase (middle position), the switching apparatus 140 is thus opened from both the outlet 120 and from the further outlet 122, wherein the two outlets are at the same time joined together via the channel 148.

The first opening position may be achieved, for example, in that the displaceable piston 142 is forced into the first chamber 141 against the spring force of the further spring 143. The second opening position may be adopted, for example, in that the displaceable piston 142 is forced into the second chamber 145 against the spring force of the spring 144. In order to enable a secure middle position, one of the two springs may be stronger, for example, but only act up to an end stop, so that the opposite, weaker spring forces the piston 142 against this end stop from the opposite side and thus secures the middle position for the displaceable piston 142.

In the sample embodiment of FIG. 2, this is accomplished for example in that the further spring 143 has, for example, twice the spring force of the spring 144. However, the further spring 143 does not act between a housing part of the switching apparatus 140 (or another end stop point) and the displaceable piston 142 itself, but rather acts on a perforated disk 146, for example, through whose opening a portion of the displaceable piston 142 extends. Since the perforated disk 146 has a larger outer diameter than the displaceable piston 142 and the first chamber 141 likewise has a larger diameter than the displaceable piston 142 or its guideway, the perforated disk 146 can only be displaced inside the first chamber 141. The stronger further spring 143 therefore forces the perforated disk 146 and therefore likewise the displaceable piston 142 at most up to the end of the first chamber 141. The displaceable piston 142 may have for this purpose a steplike broadening, against which the perforated disk 146 abuts, in order to displace it up to this point. Hence, the further spring 143 cannot accomplish any further displacement of the displaceable piston 142. Instead, only the spring force of the spring 144 acts on the piston 142, if it has moved further into the opposite second chamber 145, which thus forces the displaceable piston 142 back against the perforated disk 146.

A first throttling device 151 is configured optionally along the first control line 158. Likewise, a second throttling device 152 may be configured along the second control line 159. These throttling devices 151, 152 throttle the pressure equalization and constitute a dampening. They thus prevent a disruptive oscillation of the displaceable piston 142, for example during a pressure venting. Without these throttling devices 151, 152, the pressure might change suddenly and thereby cause an “excessive oscillation” of the piston 142. Especially in the case of hot oil with low viscosity, these oscillations of the piston 142 (valve piston) may occur. In order to effectively suppress such oscillatory behavior, throttling devices 151, 152 are adapted accordingly to the switching pressure pS.

The expansion tank 60 is configured in its size such that it can take up excess oil (hydraulic fluid) when heated by way of the leakage or drain line 62 from the pressure generator. A pressure of 5 bar may prevail here, for example, in the resting state. The two further check valves 70, 80 have for example an opening pressure of 6 bar and serve during active pump operation for draining the leak rates produced by the gear pump to the respective pressureless working cylinder side. In this way, furthermore, a pressure build-up is prevented in the expansion tank 60 and the oil supply of the system is assured.

The functioning of the system shown as an example in FIG. 2 shall be explained more closely with the aid of the following figures.

FIG. 3 shows a pressure build-up due to a steering demand. The internal system pressure of the exemplary closed hydraulic system, for example, is 5 bar. If the pressure generator 50 provides a pressure for the steering demand at the inlet 110 of the device which is greater than the switching pressure pS (such as 7 bar), the pressure increases in the first control line 158 and thus in the first chamber 141 as well above the switching pressure pS. Due to the pressure applied from the left end face, the displaceable piston 142 is moved to the right against the force of the spring 144, so that the second opening position is taken up. In this second opening position the further inlet 112 is connected to the further outlet 122, but the inlet 110 is not connected to the outlet 120. For as long as the pressure built up by the pump 50 at the inlet 110 does not yet exceed the first opening pressure p1 (e.g., 8 bar) of the first check valve 131, the steering gear is not yet pressurized. Therefore, the pressure if the pressure generator 50 continues to increase the pressure is at first only increased internally, but not yet passed on to the steering gear 90.

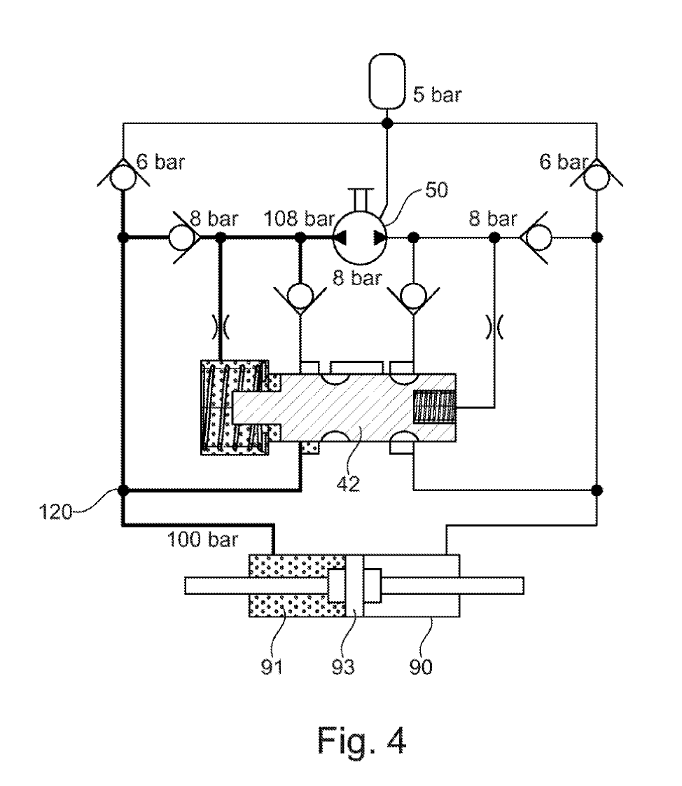

FIG. 4 shows the situation when the pressure from the pressure generator 50 rises so much that the hydraulic fluid arrives by way of the first check valve 131 in the first working cylinder 91 of the steering gear 90. For example, the pressure generator 50 may build up a pressure of 108 bar at the inlet 110. This pressure of 108 bar means that a pressure of around 100 bar is built up in the first working cylinder 91 of the steering gear 90, if the first opening pressure p1 of the first check valve 131 is 8 bar, for example. Furthermore, the displaceable piston 42 remains in the second opening position, so that likewise no back flow is possible from the outlet 120 through the switching apparatus 140 to the pressure generator 50. The increased pressure (for example 100 bar) in the first working cylinder 91 of the steering gear 90 exerts a pressure on the working piston 93, which possibly moves to the right, so that the volume of the first working cylinder 91 is increased accordingly.

According to sample embodiments, the pressure generator 50 can be relieved of load while maintaining such a target pressure. For this, the pressure generator 50 may be switched off, for example, until a pressure lower than the first opening pressure p1 of the first check valve 131 is established. However, as long as the pressure at the inlet 110 is still greater than the switching pressure pS, the piston 142 will remain at the right end stop (second opening position) and thus prevent a pressure dissipation in the working cylinder 91 of the exemplary steering gear 90, since the flow path between the outlet 120 and the inlet 110 (still) remains closed.

This is especially advantageous if the pressure in the first working cylinder 91 needs to be maintained for a lengthy time (for example, if the steered wheel strikes against a curb stone or also when driving along lengthy curves), so that the steering action continues to be ensured, yet the pressure generator 50 is not under load.

The pressure dissipation at the inlet 110 may occur, for example, by way of leakage rates of the pressure generator 50, wherein this pressure dissipation at the pressure connectors is often slow in its occurrence. In order to speed up the pressure dissipation, for example, the switching pressure pS may be chosen such that it is able to turn the motor or the pump 50 backward solely by the available pressure at the pressure connector and in this way produce a pressure equalization on both sides of the pressure generator 50.

FIG. 5 shows a procedure for active pressure reduction in the working cylinder 91 (for example to 80 bar). In order to accomplish this, the pressure at the outlet of the pressure generator 50 may be further lowered by briefly operating the pressure generator 50 in an opposite direction and thus decreasing the pressure in the first chamber 141. Once the pressure has fallen below the switching pressure pS, the piston 142 moves in the direction of the middle position and thus opens the flow path from the outlet 120 to the inlet 110. This in turn leads to a pressure rise at the inlet 110, which in turn increases the pressure in the first chamber 141 by way of the first control line 158 and moves the displaceable piston 142 back once more to the second opening position. Hence, the pressure at the inlet 110 remains nearly constantly at the value of the switching pressure pS during the entire pressure dissipation phase.

This process may be continued in order to drain the hydraulic fluid, for example, through the pressure generator 50. The dissipated energy of the system pressure will be released in the form of heat in the switching apparatus 140. Only a minimal power loss occurs in this phase at the pressure generator 50 itself and, in particular, at an electric motor for example (not shown).

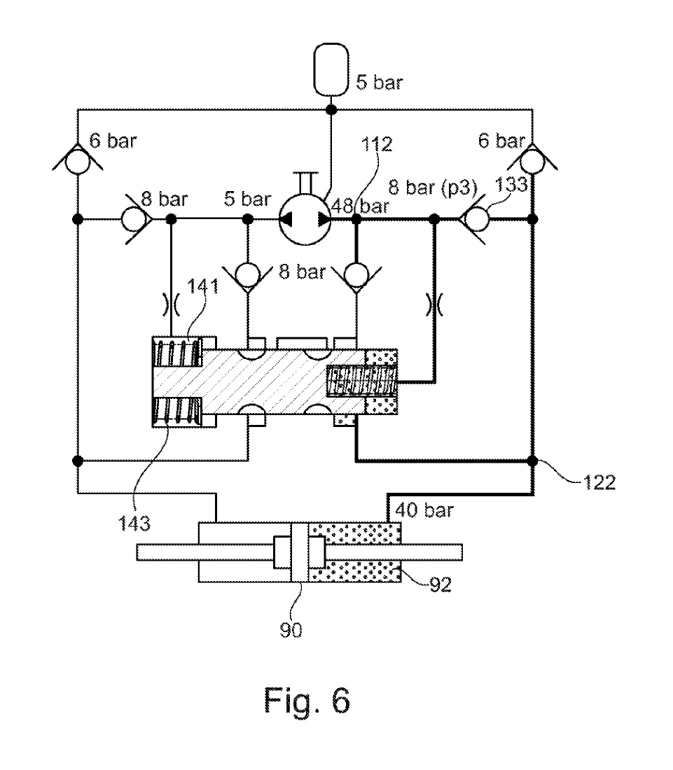

FIG. 6 shows the functioning of the device 100 during a steering movement in the opposite steering direction, during which the pressure generator 50 produces an increased pressure at the further inlet 112. In this case, when the switching pressure pS at the further inlet 112 is exceeded, the displaceable piston 142 is moved to the first opening position. In the first opening position, the fluid flow from the further outlet 122 to the further inlet 112 is interrupted. Furthermore, when the third opening pressure p3 at the further inlet 112 is exceeded, the third check valve 133 is opened and hydraulic fluid gets into the second working cylinder 92 of the steering gear 90 by way of the third check valve 133 and successively increases the pressure there. This produces the steering action in the opposite direction.

The device 100 may have a mirror symmetrical design, so that the above described functions (pressure dissipation, load relief) are also carried out for a steering in the opposite direction. Hence, the target pressure in the second working cylinder 92 is likewise maintained upon reaching a target pressure, even if the pressure generator 50 is switched off and the pressure drops at the further inlet 112. However, if the pressure at the further inlet 112 drops below the switching pressure pS, this causes the further spring 143 to move the displaceable piston 142 to the second opening position and thus open a flow path from the further outlet 122 to the inlet 112. This, once again, results in a pressure dissipation at the further outlet 122. But since the pressure at the further inlet 112 is increased in this case, the pressure in the second chamber 145 likewise rises and, when the switching pressure pS is reached, the piston 142 returns to the first opening position. Therefore, the pressure at the further inlet 112 remains constant during this pressure dissipation phase.

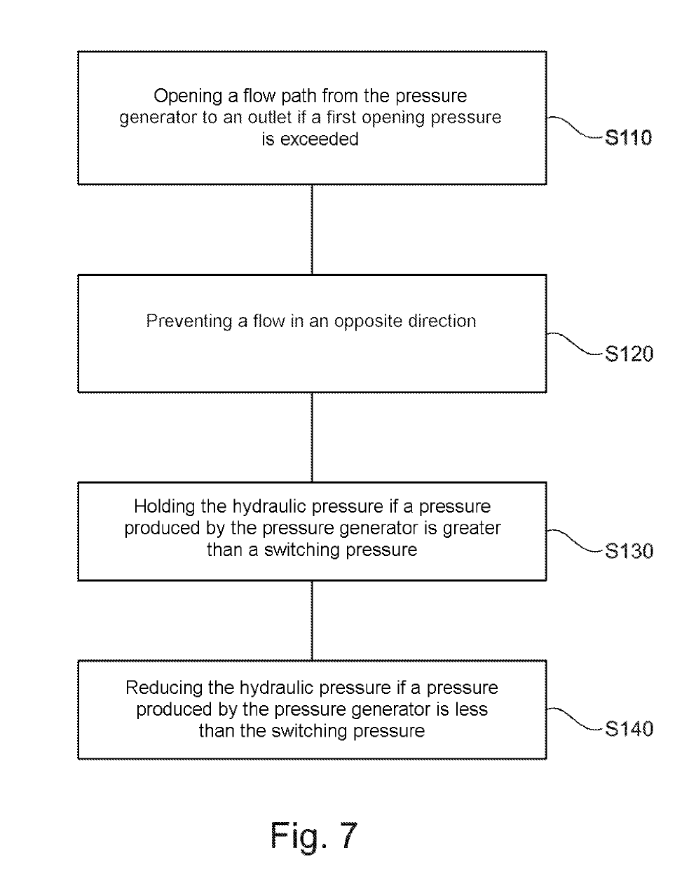

FIG. 7 shows a flow chart for a method of maintaining a hydraulic pressure p which can be set by a pressure generator. The method involves the steps: opening S110 a flow path from the pressure generator 50 to an outlet 120 if a first opening pressure p1 is exceeded, in order to thereby build up the hydraulic pressure p at the outlet 120; preventing S120 a flow in an opposite direction; holding S130 the hydraulic pressure p until a pressure p0 produced by the pressure generator 50 is greater than a switching pressure pS; and reducing S140 the hydraulic pressure p if a pressure p0 produced by the pressure generator 50 is less than the switching pressure pS, wherein the switching pressure pS is less than the first opening pressure p1.

All of the previously described functions of the devices can be implemented as further optional steps of the method.

Important aspects of sample embodiments may be summarized as follows.

The exemplary hydraulic gear pump 50 produces the hydraulic pressure for the steering gear 90. At the same time, the position of the piston 142 is controlled by the system pressure, wherein corresponding chambers 141, 145 can be actuated or moved by the two end faces of the piston 142 of the gear pump 50. After reaching a target pressure, the pump pressure can be dissipated, wherein the pressure is maintained at the outlet 120 (or the further outlet 122). When the motor is switched off, the piston 142 returns to its middle position on account of the spring forces 143, 144 and the gear pump 50 is released (backup mode). The channel 148 then connects the outlet 120 to the further outlet 122, so that the working cylinders 91, 92 of the steering gear 90 are likewise interconnected. This has the effect that steering movements now only result in a displacing of the working piston 93 inside the steering gear 90, but are not forced to carry along the pressure generator 50. Instead, the pressure generator 50 can remain in the position of rest. The pressure established at the inlet 110 or at the further inlet 112 during the pressure dissipation phase (e.g., 7 bar) should in any case be higher than the pressure for driving the exemplary gear pump 50 in the currentless state, so that the switching pressure pS automatically causes the pump 50 to move back by itself.

In sample embodiments, the spring 144 has for example a spring force of 10 N and the further spring 143 a force of 20 N, these being only examples. In other sample embodiments, the springs provide other forces. However, it makes sense for the spring force of the further spring 143 to be twice or half as strong as the spring force of the spring 144, so that the corresponding switching pressure pS is the same size for movements of the displaceable piston 142 in both directions (but this is not absolutely necessary).

The control valve (switching apparatus 140) present thus serves at the same time as a backup valve, making possible a release of the pump mechanism 50 in the backup mode (for example, during a power outage). In other sample embodiments, the device together with the hydraulic steering system may constitute a fully encapsulated hydraulic system with integrated control valve 140, which can be used for closed as well as for open hydraulic systems.

Hence, sample embodiments of the present invention for both closed as well as open hydraulic systems make possible a complete relieving of the load on the pump/motor unit after reaching a target pressure. According to sample embodiments, no pump pressure is needed for the attainment and dissipation of the pressure.

Since the pump pressure does not need to be permanently maintained, advantageously the motor power loss of the pump 50 can be reduced (for example, cut in half). Furthermore, practically no power losses need to be provided or absorbed by the motor during the pressure maintaining or during a slow pressure dissipation. The pressure generator 50 serves only for producing the system pressure (until the pressure build-up is completed) and for actuating the switching apparatus 140 by way of the control lines 158, 159, where only a relatively slight pressure is needed (e.g., the switching pressure pS). The relieving of the load on the pressure generator 50 decreases the wear and thereby increases the service life of the pressure generator 50. By contrast with the prior art, the energy during the pressure maintaining or the pressure dissipation is released through the valves, so that the motor is not placed under load. But an energy release through the switching apparatus 140 or the valves is not critical, as compared to the motor, which would be subjected to greater wear under the high load. Since the power loss is absorbed by the switching apparatus or the valves, there is less thermal load placed on the pump or the motor, so that no separate cooling is required. Finally, the hydraulic oil is likewise spared.

For the switching apparatus 140 it is possible to use, for example, a slide valve or also a proportional valve, but not a magnetic valve. A magnetic valve generally cannot provide the defined functions.

Sample embodiments may be used for open hydraulic systems and then afford advantages in particular when a high hydraulic pressure needs to be held constant over a lengthy time (for example in crane equipment, hoisting equipment, gripping equipment, etc.).

A further advantage is that the actuation of the system is entirely hydraulic and no electrical actuation is needed. The pump, for example, may be configured in a closed system so that it works in both directions and depending on which side requires pressure the pressure is built up on the one side and dissipated on the other side. In an open system (see FIG. 1), the oil for example is only pumped away from a tank and not pumped back and forth between two sections of the system.

The features of the invention disclosed in the specification, the claims and the figures may be essential to the implementing of the invention either individually or also in any given combination.

The LIST OF REFERENCE NUMBERS is as follows:
50 Pressure generator
51 Motor
60 Surge tank
70,80 Check valves
90 Steering gear
91 First working cylinder
92 Second working cylinder
93 Working piston
100 Device
110 Inlet
112 Further inlet
120 Outlet
122 Further outlet
131, 132, Check valves
140 Switching apparatus
141 First chamber
142 Displaceable piston
143 Further spring
144 Spring
145 Second chamber
148 Channel
158, 159 Control lines
151, 152 Throttling devices
p Hydraulic pressure
p0 Pressure produced by pressure generator
pW Further hydraulic pressure
pS Switching pressure
pL Idling pressure
p1 First opening pressure
p2 Second opening pressure
p3 Third opening pressure
p4 Fourth opening pressure

1-14. (canceled)

15. A device for maintaining a hydraulic pressure, which can be set by a pressure generator, comprising:
an inlet for coupling to the pressure generator;
an outlet for providing the hydraulic pressure;
at least a first check valve, which is designed to open a flow path from the inlet to the outlet when a first opening pressure is exceeded and to prevent flow in the opposite direction; and
a switching apparatus between the inlet and the outlet, wherein the switching apparatus is designed to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure.

16. The device of claim 15, wherein the switching apparatus includes a control valve with a displaceable piston, wherein the piston in a first position opens a flow path between the outlet and the inlet and in a second position closes the flow path between the outlet and the inlet and the control valve is designed to shift the piston into the first position if the pressure produced is less than the switching pressure, and to shift it into the second position if the pressure produced is greater than the switching pressure.

17. The device of claim 16, wherein the control valve has at least a first chamber and a spring and the device further includes a first control line, which connects the first chamber fluidically to the inlet, wherein the first control line brings about a pressure equalization between the first chamber and the inlet and the spring brings about a biasing of the piston in the direction of the first position, so that the switching pressure is defined by the spring.

18. The device of claim 17, wherein the pressure generator includes a first pressure connector and a second pressure connector, and wherein the inlet is coupled to the first pressure connector, further comprising:
a further inlet for coupling to the second pressure connector of the pressure generator;
a further outlet for providing a further hydraulic pressure; and
a third check valve, which is adapted to open a flow path from the further inlet to the further outlet when a third opening pressure is exceeded and to prevent a flow in the opposite direction;
wherein the switching apparatus connects the further outlet and the further inlet and is adapted to reduce the further hydraulic pressure at the further outlet if a pressure produced by the pressure generator at the further inlet is less than the switching pressure, wherein the switching pressure is less than the third opening pressure.

19. The device of claim 18, wherein the switching apparatus includes a second chamber and a further spring and the device further includes a second control line, which fluidically connects the second chamber to the further inlet, wherein the second control line brings about a further pressure equalization between the second chamber and the further inlet and the further spring brings about a biasing of the piston in the direction of the second position, so that the switching pressure is determined by the spring.

20. The device of claim 17, further comprising:
a first throttling device along the first control line to bring about a throttling of the pressure equalization; and/or
a second throttling device along the second control line to bring about a throttling of the further pressure equalization.

21. The device of claim 20, further comprising:
a second check valve, which is configured between the switching apparatus and the inlet in order to make possible a flow from the switching apparatus when a second opening pressure is exceeded and to prevent a flow in the opposite direction, wherein the second opening pressure is greater than the switching pressure; and/or
a fourth check valve, which is configured between the switching apparatus and the further inlet in order to make possible a flow from the switching apparatus when a fourth opening pressure is exceeded and to prevent a flow in the opposite direction, wherein the fourth opening pressure is greater than the switching pressure.

22. The device of claim 21, wherein the second opening pressure of the second check valve is equal to the first opening pressure of the first check valve and/or wherein the fourth opening pressure of the fourth check valve is equal to the third opening pressure of the third check valve.

23. The device of claim 16, wherein the pressure generator includes at least one pressure connector for the coupling to the inlet or the further inlet of the device and the pressure generator is further adapted to make possible a back flow through the pressure generator from the at least one pressure connector when an idling pressure is exceeded at the at least one pressure connector, characterized in that the switching pressure is greater than the idling pressure.

24. A hydraulic system, comprising:
a pressure generator for producing a hydraulic pressure at a pressure connector; and
a device for maintaining the hydraulic pressure, which is set by the pressure generator, including:
an inlet for coupling to the pressure generator;
an outlet for providing the hydraulic pressure;
at least a first check valve, which is designed to open a flow path from the inlet to the outlet when a first opening pressure is exceeded and to prevent flow in the opposite direction; and
a switching apparatus between the inlet and the outlet, wherein the switching apparatus is designed to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure.

25. The hydraulic system of claim 24, wherein the pressure generator includes a hydraulic gear pump and the outlet and further outlet of the device can be coupled to a steering gear.

26. A power steering system, comprising:
a steering gear; and
a hydraulic system, including:
a pressure generator for producing a hydraulic pressure at a pressure connector; and
a device for maintaining the hydraulic pressure, which is set by the pressure generator, including:
an inlet for coupling to the pressure generator;
an outlet for providing the hydraulic pressure;
at least a first check valve, which is designed to open a flow path from the inlet to the outlet when a first opening pressure is exceeded and to prevent flow in the opposite direction; and
a switching apparatus between the inlet and the outlet, wherein the switching apparatus is designed to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure.

27. A vehicle, comprising:
a power steering system, including:
a steering gear; and
a hydraulic system, including:
a pressure generator for producing a hydraulic pressure at a pressure connector; and
a device for maintaining the hydraulic pressure, which is set by the pressure generator, including:
an inlet for coupling to the pressure generator;
an outlet for providing the hydraulic pressure;
at least a first check valve, which is designed to open a flow path from the inlet to the outlet when a first opening pressure is exceeded and to prevent flow in the opposite direction; and
a switching apparatus between the inlet and the outlet, wherein the switching apparatus is designed to hold the hydraulic pressure at the outlet if a pressure produced by the pressure generator is greater than a switching pressure, and to reduce the hydraulic pressure at the outlet if a pressure produced by the pressure generator is less than the switching pressure, wherein the switching pressure is less than the first opening pressure.

28. A method for maintaining a hydraulic pressure which is settable by a pressure generator, the method comprising:
opening a flow path from the pressure generator to an outlet if a first opening pressure is exceeded, so as to build up the hydraulic pressure at the outlet;
preventing a flow in an opposite direction;
holding the hydraulic pressure until a pressure produced by the pressure generator is greater than a switching pressure; and
reducing the hydraulic pressure if a pressure produced by the pressure generator is less than the switching pressure, wherein the switching pressure is less than the first opening pressure.
